(19) United States
(12) Patent Application Publication
(10) Pub. No.: US 2010/0306095 A1
(43) Pub. Date: Dec. 2, 2010

(54) METHOD FOR FINANCIAL FORECASTING

(76) Inventors: Gregory Olson, Azusa, CA (US); Robin Nillie Olson, Azusa, CA (US)

Correspondence Address: COHEN I.P. LAW GROUP, P.C., 9025 Wilshire Blvd., Suite 301, Beverly Hills, CA, 90211, US

(21) Appl. No.: 12/477,041

(22) Filed: Jun. 2, 2009

(51) Int. Cl. G06Q 40/00

(52) U.S. Cl. 705/35

(57) ABSTRACT

A method and system for financial allocation and forecasting for calculating daily, weekly, and monthly spending rates that can be used by a company or a person is disclosed, providing an over/under forecast variance. The forecast variance is converted to the number of days required to reduce all spending to zero to eliminate over spending. The method receives financial data either manually or by a program application and treats all transactions as cash equivalents. The method includes a plurality of program applications formulated to generate a plurality of forecasting parameters. A rate factor which is a subjective decision of the user is received from a range −3 to +3 to automatically calculate an under/over value variance. The invention utilizes Gregorian calendar that has a five week month occurring every three months to identify 7.7% savings of yearly income. Further, the method converts the irregular yearly and quarterly expenses into monthly amounts and put the expenses in savings. The method categorizes the spending into need which is essential and wants which is optional for the user. It integrates all financial decisions made within the invention into a forecast of today's cash balance.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to a computerized financial forecasting and budgeting method, and more particularly to a method and system for financial allocation and forecasting that produces daily and weekly spending rates and under/over forecasting reports to evaluate spending on things.

### DISCUSSION OF RELATED ART

Budget or financial forecast refers to estimating future income, expenses, debts and assets. A personal financial forecast usually refers to the means by which cash will be acquired to cover future expenses, for instance through earning, borrowing or using saved cash. The financial forecast program can be used for all age groups and appeals both professional and non-professional planners. Past spending and personal debt are considered when creating a personal budget or finance forecast and it allocates future personal incomes towards expenses, savings and debt repayment.

Accounting and budgetary principles are typically used in determining the state of a business. U.S. Pat. No. 6,249,770 issued to Erwin, provides a computerized method and system for financial spreading and forecasting which highlights the operating profitability and cash flow generating ability of a company's operations. The method is not applicable to personal accounting systems as the personal financial measures differ from business measures in various manners. For example, individuals may not measure a financial state in terms of profit. Further, the method does not fit into personal finance due to the complex operations and human emotions and personalities are not taken into consideration. In spite of the noble efforts, the method falls short of the personal accounting and budgeting means.

U.S. Pat. No. 7,050,997 issued to Wood, explains a computer-implemented graphical personal financial budgeting and planning system that models current and planned financial information as graphical objects. Each object may have mathematical and logical equations associated with it to model a financial action. Within the software program, a user generates each graphical object, fills in the pertinent information about the object and then places the object onto a time-line. The tool displays to-do list activities accordingly for prompting the user to initiate planned actions. Therefore, the to-do list becomes the decision maker and may ignore an opportunity to buy a perfect item on sale since the tool already decided three weeks earlier that the user can not do that. However, the straight jacket method gets a person out of debt, but a person can loose the chance to buy mostly desired things and it may remove the joy out of spending and saving as well.

U.S. Patent Application No. 20020156710 issued to Ryder includes a method for determining the state of a person's finance which generates a personal finance code for setting fiscal goals. The personal finance code is associated with budgetary guidelines which are associated with spending categories, saving income requirements and time period. Once the spending categories are decided, the budget requires the user to be inflexible. If the user increases the spending amounts in one category, the user may threaten to blow the budget or plan. When the future needs do not meet the expectations in one category, the user is tempted to steal from another category to pay for it by thinking that he saves money in one category to fund another category. Moreover, the major complexity with budgeting featuring spending categories is planning for the unknown daily expenses that do not fit evenly into the monthly and yearly totals.

Therefore, there is a need for a user-friendly method that can be used in personal finance or by a company. Further, the needed method would allow the user to customize the categories either manually or by custom program to include daily spending and would show the daily and weekly spending rates along with monthly spending rate. Such a needed method would tabulate the spending into a monetary scale to provide a clear metric to determine if the spending is within the user's desired values. The present invention accomplishes these objectives.

### SUMMARY OF THE INVENTION

The present invention is a method for financial allocation and forecasting that includes a plurality of key components such as a computer and a media storage disk capable of storing a plurality of program applications. The plurality of program applications may be coupled to other program applications over a wired or wireless network. A user can manipulate the plurality of program applications depending on an operating system in use on the computer, such as Windows 3.1, Windows NT, Windows 98, UNIX or the like.

The method receives a plurality of financial data manually or by way of customized program applications. The preferred embodiment treats all the transactions involving credit card, check, cash, money order, or the like as cash equivalents. The program applications are formulated to uniquely generate a plurality of forecasting parameters that utilize the plurality of financial data for processing. The present method further generates a plurality of forecasting reports in at least one program application based on the plurality of forecasting parameters.

The present invention is specifically designed to utilize a Gregorian calendar system that has a five week month occurring every three months. The fifth week earnings are automatically allocated to savings rather than expense, thereby identifying 7.7% savings of yearly income to pay off debts or invest. Further, the bills or expenses which are not evenly spread each month are generally grouped as irregular bills and the present method converts the irregular yearly and quarterly expenses into monthly amounts and put the expenses in savings.

Program application 1 is designed for monitoring an initial monthly forecast and a today's forecast. These forecasts are based on the values associated with weekly and monthly income, monthly income allocation, cash usage and equity. The values associated with weekly and monthly income that receive financial data as input from the user may include number of weeks in month, weekly net income, and weekly gross income or the like thereby generating forecasting parameters such as weekly deduction and monthly gross income. The values associated with monthly income allocation that receive financial data from the user may include number of weeks in a month, savings for purchases and investments, irregular bills, and monthly bills thereby calculating respective forecasting parameters such as fifth week income savings, daily expenses, taxes and deductions, and fifth week taxes and deductions or the like.

The values associated with the cash usage that receive financial data as input may include prior month credit card purchases, investment purchases, additional debt payments, cash balance beginning, sale of assets (including investments), cash gifts/other cash, and additional other net income thereby calculating forecasting parameters such as cash balance today's forecast, savings purchases, total cash usage from savings, total savings from income, and total cash available as savings. The values associated with the equity receive input for financial data for assets and debts from the user or program application thereby calculating the respective forecasting parameter for resultant equity which may be utilized for further processing. The weekly and monthly income may be utilized for assessing the initial monthly forecast. The monthly income allocation may be utilized to assess both the initial monthly forecast and the today's forecast. Likewise, the cash usage and equity may be incorporated for assessing the today's forecast.

Program application 2 allocates daily spending and generates a daily and a weekly spending rate. The financial data associated with program application 2 may include day of a month and days per month. The day of a month and the days per month may be incorporated for assessing a plurality of forecasting parameters such as initial monthly forecast, today's monthly forecast, month-to-date forecast, month-to-date actual, month-to-date over (under), days over (under), remaining funds, remaining days, remaining funds daily rate, month-to-date needs, month-to-date wants, month-to-date actual total, and month-to-date actual % wants. In the present invention, an “n” or “N” indicates need for an item which is necessary for the user and a “w” or “W” indicates wants for an item which is optional for the user. The program application 2 further receives a plurality of financial data that may include day, indication for need or wants, description, and the amount spent for the particular product to generate the daily and the weekly spending rate and the number of days over/(under) the initial forecast.

Program application 3 receives day, indication for need or wants as N or W, and details of the item, and the amount spent for the particular item. The details may be fountains, book cases, vacation, visit to doctor, hobby, etc. The program application 3 allocates savings purchases to generate forecasting parameters based on the values associated with an expense type such as the “n” or “N” and “w” or W”.

The method and system receives a value factor which is a subjective decision of the user for an item utilizing program application 4. The value factor can be selected from a range −3 to +3. The program application 4 receives the indication for N or W, amount spent for the particular product and the value factor as inputs from the user. The need or wants and the amount spent for the particular product are as in the program application 2. The program application 4 generates a plurality of forecasting parameters such as wants and value adjustment to automatically calculate an under/over value variance between an actual spending rate (monthly, month-to-date, weekly, and daily) and an allocated spending rate (monthly, month-to-date, weekly, and daily), utilizing the value factor inputted by the user.

The generated under/over value variance can be judged on a zero reference value. Zero value is assessed as the money spent is equal to the value received and anything above zero, i.e. +1, +2, and +3 are measured as good or positive. On the other hand, −1, −2, and −3 meaning the user is spending more than what the user is supposed to spend. Ideally, after a few months the user can utilize the method and system to determine what best fits their own value system and to evaluate their spending habits.

The preferred embodiment facilitates incorporation of the other plurality of program applications for assets, debts, irregular bills and monthly bills. The program applications may be coded in any programming language to calculate the daily and the weekly spending rates, monthly spending rate, and savings purchases.

The present invention is a user-friendly method that can be used in personal finance or by a company. Further, the method allows the user to customize the categories either manually or by custom program to include daily spending and shows the daily and the weekly spending rates along with monthly spending rate. Moreover, the method tabulates the spending into a monetary scale to provide a clear metric to determine if the spending is within the user's desired values. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 shows a plurality of key components and the flow of information between the key components for an embodiment of the present invention;

FIG. 2 shows a logical format structure of a program application for allocating income, cash and equity;

FIG. 3 shows a logical format structure of a program application for allocating daily spending;

FIG. 4 shows a logical format structure of a program application for allocating savings purchases;

FIG. 5 shows a logical format structure of a program application for evaluating a daily monetary value factor and an under/over value variance;

FIG. 6 shows a sample report formulae table of a program application for income, cash and equity;

FIG. 7 shows a sample report formulae table of a program application for daily spending;

FIG. 8 shows a sample report formulae table of a program application for savings purchases;

FIG. 9 shows a sample report formulae table of a program application for generating a value variance;

FIG. 10 shows a summary of a plurality of inputs utilized by a plurality of program applications;

FIG. 11 shows a summary of a plurality of outputs in a plurality of program applications; and

FIG. 12 shows an operational flow chart for a method for financial allocation and forecasting.

### DETAILED DESCRIPTION OF THE PREFERRED EMBODIMENT

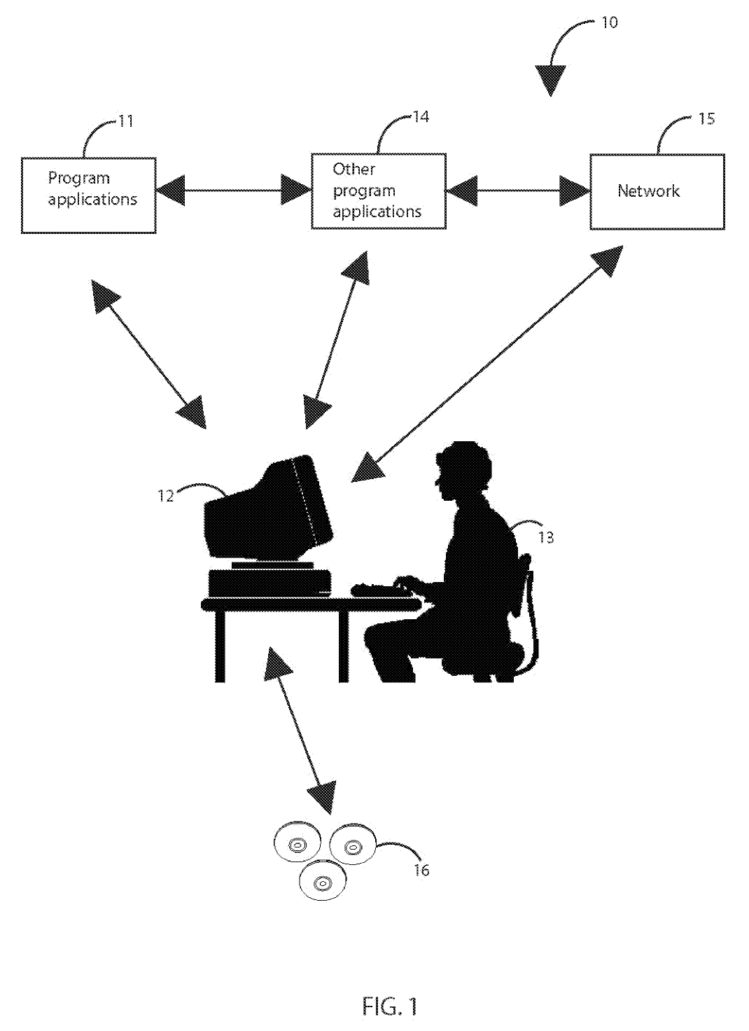

FIG. 1 illustrates a plurality of key components and the flow of information between the key components 10 according to the present invention. The plurality of key components 10 may include a computer 12 and a media storage disk 16 such as a compact disk (CD) or hard disk that is capable of storing a plurality of program applications 11. The plurality of program applications 11 may be coupled to other program applications 14 over a wired or wireless network 15 such as a local area network or the internet. A user 13 can manipulate the plurality of program applications 11 depending on an operating system (not shown) in use on the computer 12, the operating system (not shown) may be Windows 3.1, Windows NT, Windows 98, Unix, or the like. The plurality of program applications 11 may receive data manually or by way of at least one customized program application.

The present invention is a method and system for financial allocation and forecasting, specifically designed to utilize a Gregorian calendar system that has a five week month occurring every three months. The fifth week earnings are automatically allocated to savings rather than expense, thereby identifying 7.7% savings of yearly income to pay off debts or invest. Further, the invention generally groups the bills or expenses which are not evenly spread each month such as real estate, taxes, insurance, auto license fee and Christmas as irregular bills. The irregular bills for spending dynamics are complex and mentally impossible to plan for monthly savings which necessitates the present method to convert the irregular yearly and quarterly expenses into monthly amounts and put the expenses in savings. Daily expenses are unpredictable and also very difficult to plan for accurately. The present invention simplifies the forecasting method by using a daily and a weekly spending rate based on desired savings. It is a further feature of the preferred embodiment to treat all the transactions involving credit card, check, cash in hand, money order, or the like as cash equivalents. Finally, it is an additional feature to convert the over/under dollar variance into days and not just money, so that the user can ascertain exactly how many days are required to remove an unfavorable variance by reducing all daily spending to zero.

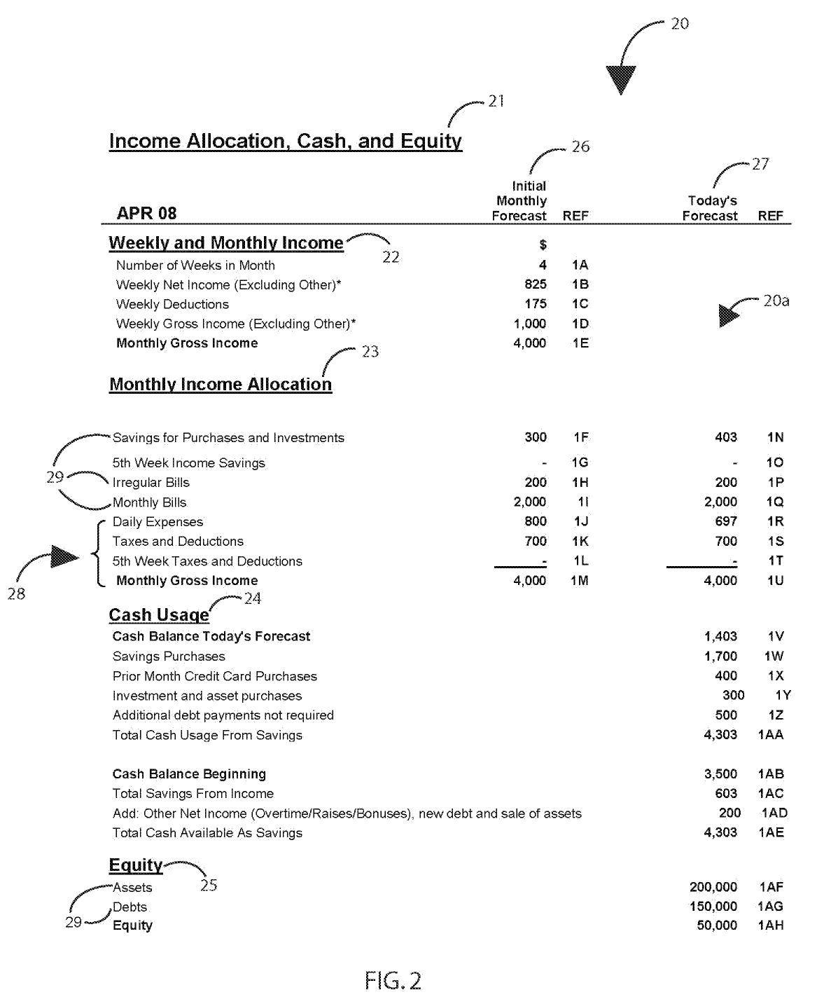

Now, referring to FIG. 2, illustrates a logical format structure of program application 1 generally indicated as 20. The program application 20 is formulated to uniquely generate a plurality of forecasting parameters 28 that utilize a plurality of financial data 29 for processing. The program application 20 automatically calculates an initial monthly forecast 26 and a today's forecast 27. These forecasts 26, 27 are based on the values associated with weekly and monthly income 22, monthly income allocation 23, cash usage 24 and equity 25. The method further generates a plurality of forecasting reports 20a in the program application 20 based on the plurality of forecasting parameters 28. The plurality of forecasting reports 20a includes a plurality of forecasting metrics.

The values associated with the weekly and monthly income 22 that receive financial data 29 as input from the user 13 or other program applications 14, or the network 15, may include number of weeks in month, weekly net income, and weekly gross income or the like thereby generating forecasting parameters 28 such as weekly deduction and monthly gross income. The values associated with the monthly income allocation 23 that receive financial data 29 from the user 13, or other program applications 14, or the network 15, may include savings for purchases and investments, irregular bills, and monthly bills thereby calculating respective forecasting parameters 28 such as fifth week income savings, daily expenses, taxes and deductions, and fifth week taxes and deductions or the like.

The values associated with the cash usage 24 that receive financial data 29 as input from the user 13 or other program applications 14, or the network 15, may include prior month credit card purchases, investment purchases, additional debt payments, sale or collection of assets for cash, cash balance beginning, and additional other net income thereby calculating forecasting parameters 24 such as cash balance today's forecast, savings purchases, total cash usage from savings, total savings from income, and total cash available as savings. The values associated with the equity 25 receive input for financial data 29 for assets and debts from the user 13 or other program applications 14, or the network 15, thereby calculating the respective forecasting parameter 28 for resultant equity which may be utilized for further processing. The weekly and monthly income 22 may be incorporated for assessing the initial monthly forecast 26. The monthly income allocation 23 may be incorporated to assess both the initial monthly forecast 26 and today's forecast 27. Likewise, the cash usage 24 and equity 25 may be incorporated for assessing the today's forecast 27.

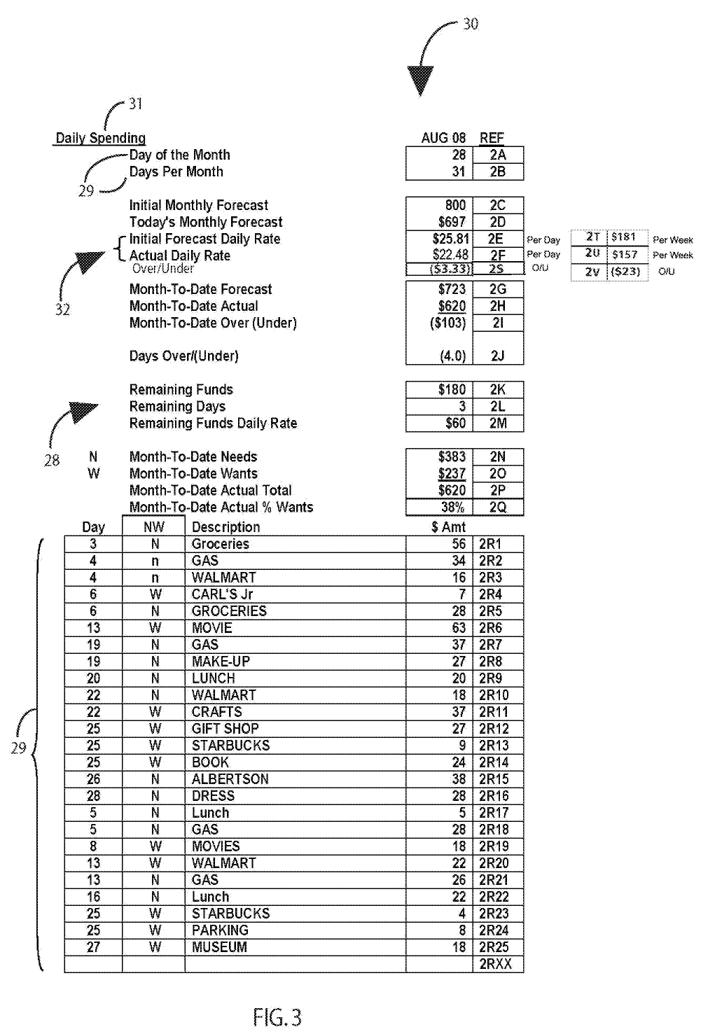

Referring to FIG. 3, a logical format structure of program application 2 generally indicated as 30 for allocating daily spending 31 and evaluating a daily and a weekly spending rate 32 are illustrated. The program application 30 receives plurality of financial data 29 for allocating daily spending 31. The plurality of financial data 29 received in the program application 30 is utilized to generate plurality of forecasting parameters 28 thereof. The financial data 29 associated with the program application 30 may include day of a month and days per month. The day of a month and the days per month may be incorporated for assessing a plurality of forecasting parameters 28 such as initial monthly forecast, today's monthly forecast, month-to-date forecast, month-to-date actual, month-to-date over (under), days over (under), remaining funds, remaining days, remaining funds daily rate, month-to-date needs, month-to-date wants, month-to-date actual total, and month-to-date actual % wants. In the present invention, an “n” or “N” indicates need for any item which is necessary and a “w” or “W” indicates wants for any item which is optional or for luxury purpose for the user 13. The program application 30 further receives plurality of financial data 29 that may include day, indication for need or wants, description, and the amount spent for the particular item to generate the daily spending rate 32.

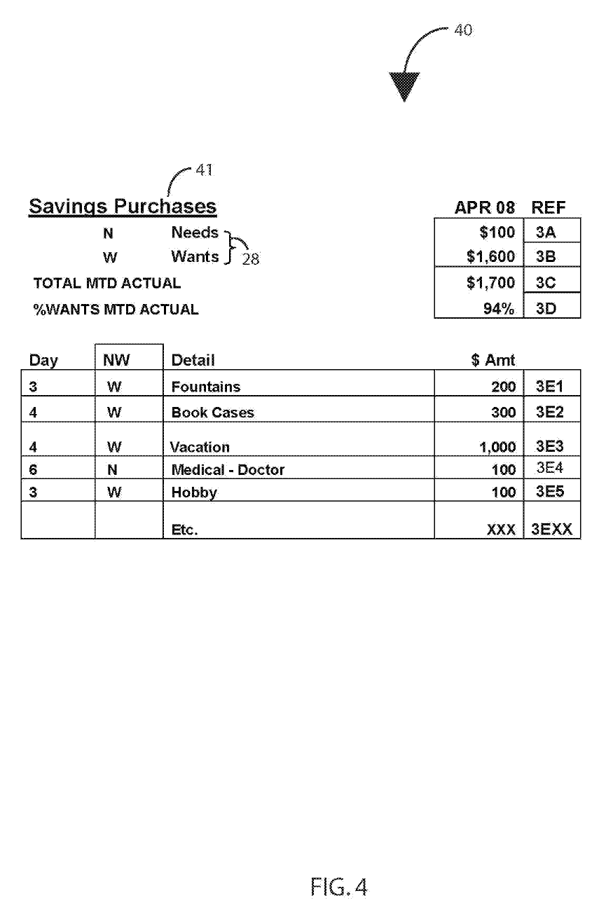

FIG. 4 illustrates a logical format structure of program application 3 generally referred as 40 for allocating savings purchases 41. The program application 40 receives day, indication for need or wants as N or W, details of the item, and the amount spent for the particular item. The details of the item may be fountains, book cases, vacation, visit to doctor, hobby, etc. Based on the values associated with an expense type such as the “n” or “N” indicating the need which is a necessary item and the “w” or W” indicating a want which may be an optional item for the user, the program application 40 generates forecasting parameters 28.

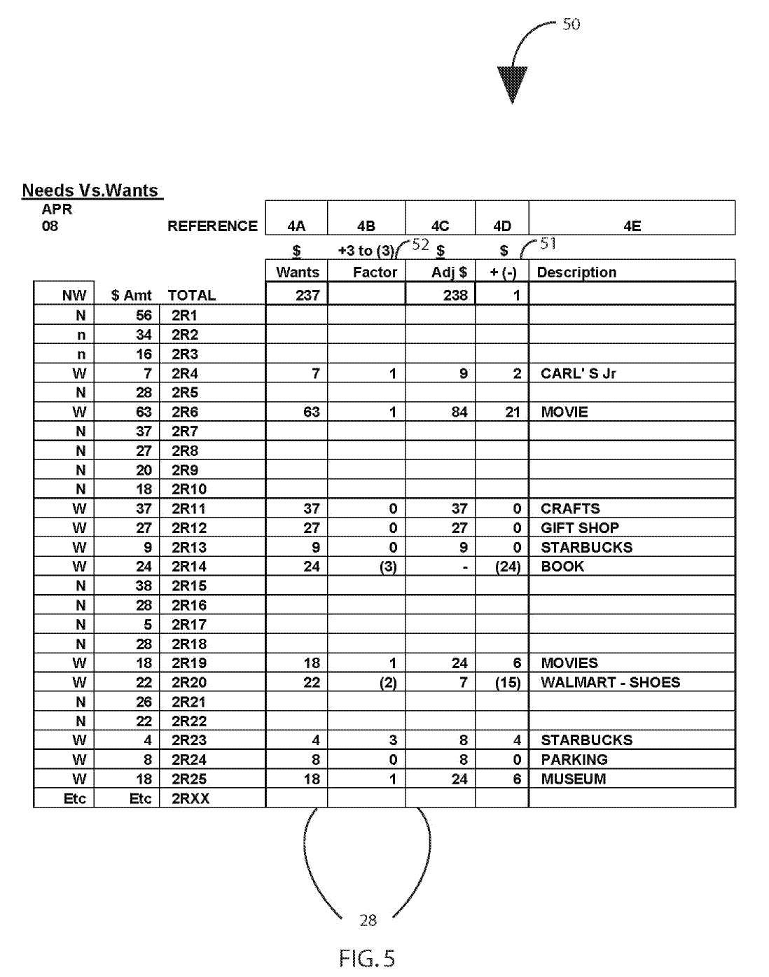

A logical format structure of program application 4 generally indicated as 50 for evaluating an under/over value variance 51 is shown in FIG. 5. The program application 50 receives indication for N or W, amount spent for the particular product, and a value factor 52 as inputs from the user 13. The value factor 52 is a subjective decision of the user 13 inputted in program application 50 which can be selected from a range −3 to +3. The need or wants and the amount spent for the particular item are as in the program application 30. Based on the value factor 52 inputted by the user 13, plurality of forecasting parameters 28 such as wants and value dollar adjustment are generated to automatically calculate the under/over value variance 51. The value variance 51 facilitates the user 13 to evaluate the variation from the user's spending preferences and values.

Thus the present invention allows the user 13 to evaluate the under/over value variance 51 between an actual spending amount and a value adjusted amount. The under/over value variance 51 is judged on a zero reference value. Zero value is assessed as the money spent is equal to the value received and anything above zero, i.e., +1, +2, and +3 are measured as good or positive. The user should continue spending the same amount or more on that type of purchase, depending on how high the value is. The higher the value, the more money should be allocated to that type of spending, verses spending that is of lower value. On the other hand, −1, −2, and −3, mean the user 13 is spending more than what the user values to spend, indicating a waste of money spent.

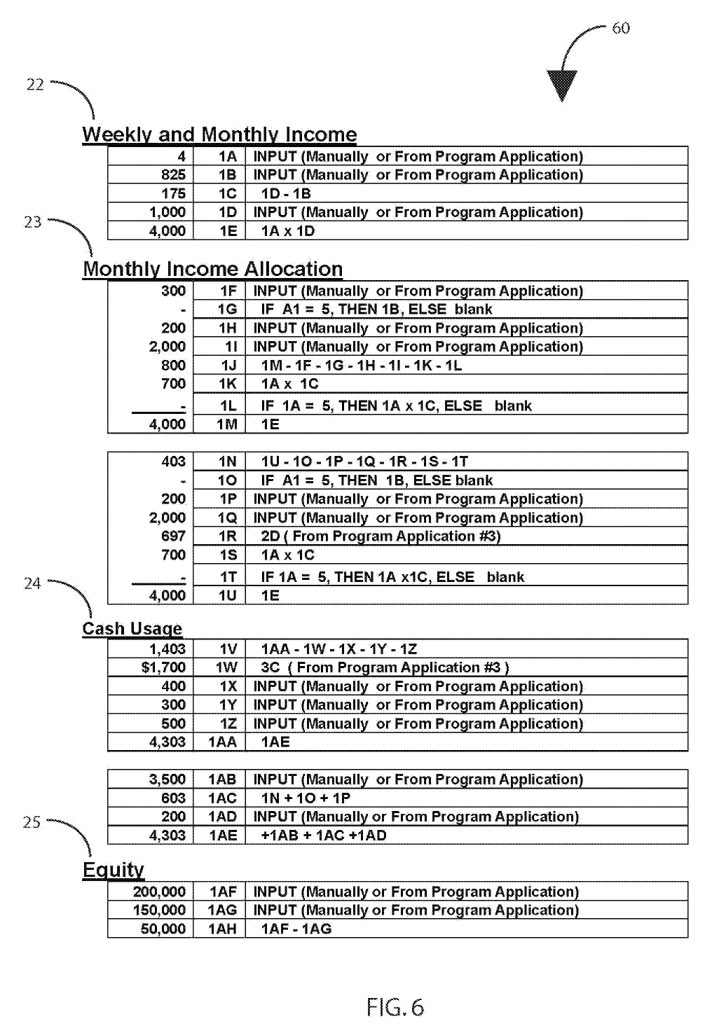

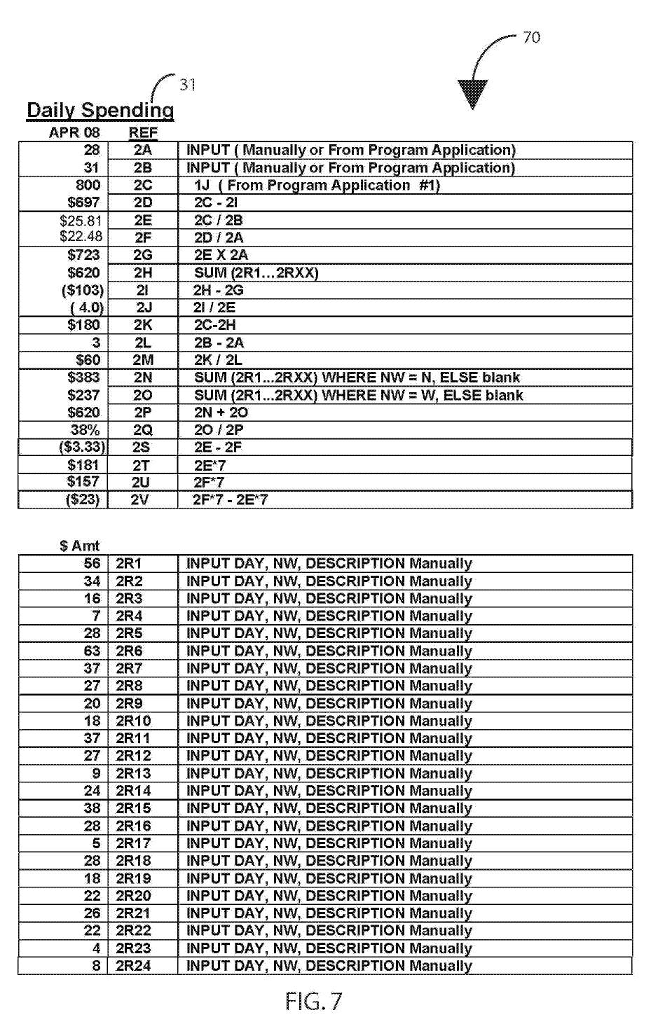

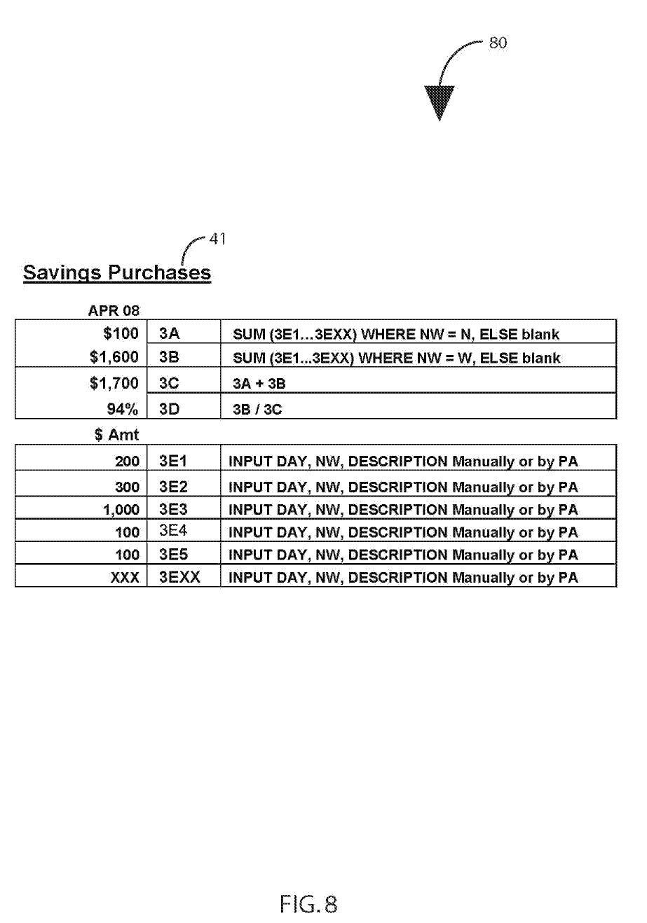

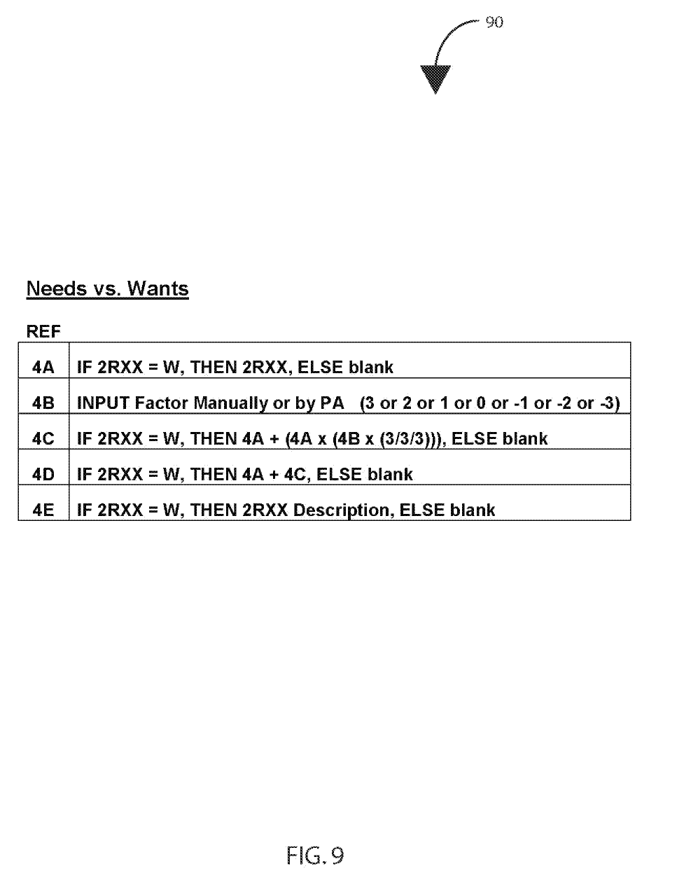

FIG. 6 illustrates a sample report formulae table of program application 20, indicated as 60 for weekly and monthly income 22, monthly income allocation 23, cash usage 24 and equity 25. FIG. 7 illustrates a sample report formulae table of program application 30, indicated as 70 for daily spending 31 and FIG. 8 shows a sample report formulae table of program application 40, indicated as 80 for savings purchases 41. Turning to FIG. 9, a sample report formulae table of program application 50, indicated as 90 for generating the under/over value variance 51 is illustrated.

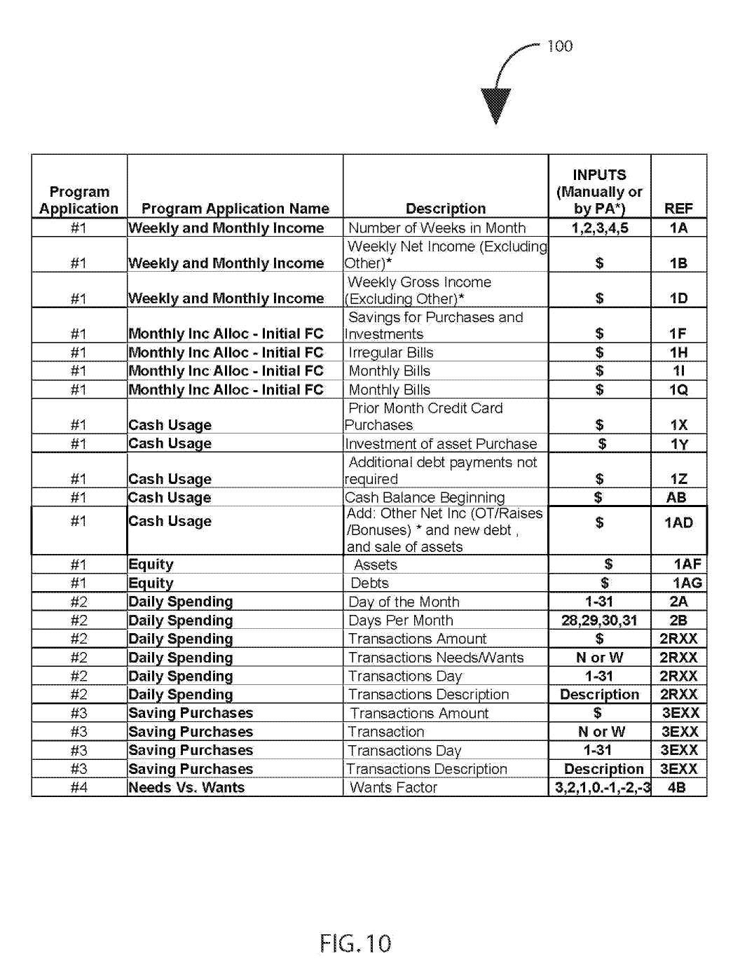

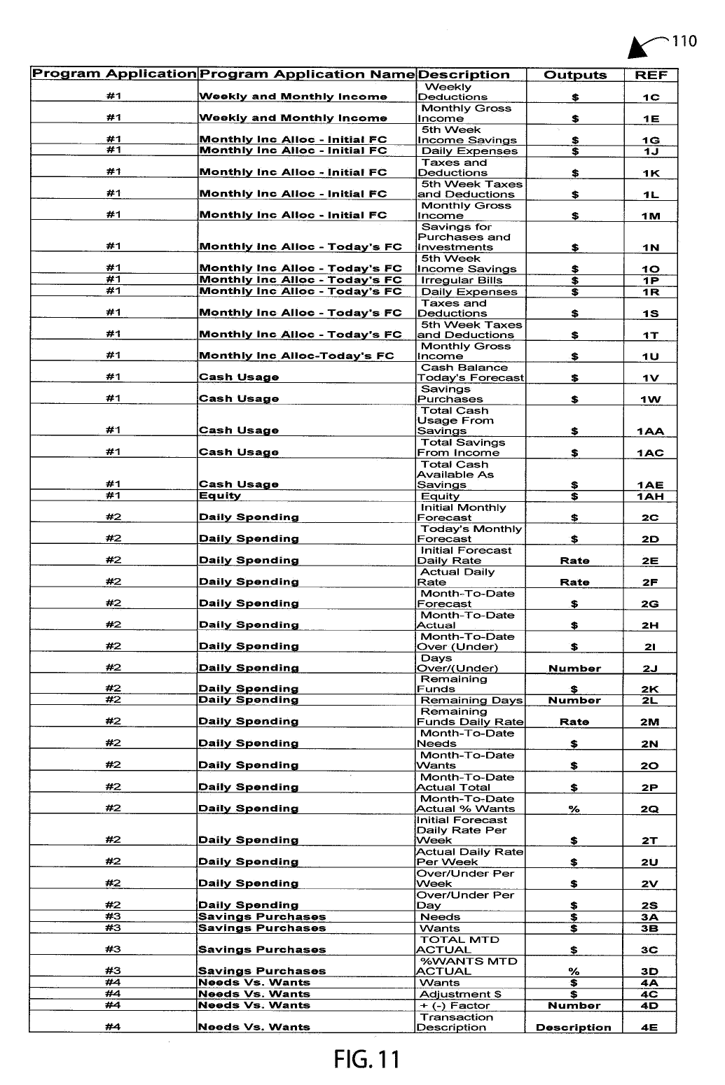

FIG. 10 shows a summary of a plurality of inputs 100 utilized in the plurality of program applications 11. FIG. 11 shows a summary of a plurality of outputs 110 in the plurality of program applications 11.

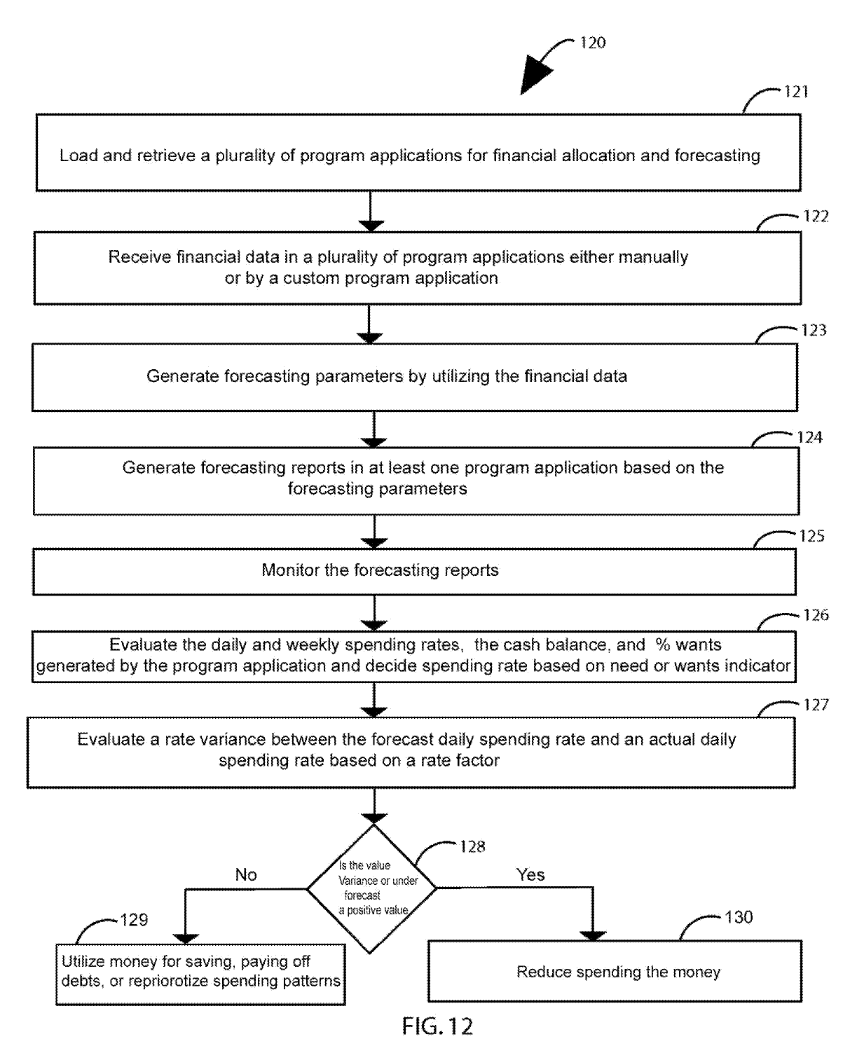

FIG. 12 shows an overview of an operational flow chart 120 for the method for financial allocation and forecasting. The financial allocation and forecasting for a person or a company may be initiated by loading and retrieving the plurality of program applications as indicated at block 121. The plurality of program applications are designed in such a manner to receive financial data either manually or by a custom program application as indicated at block 122. The plurality of financial data being processed to generate a plurality of forecasting parameters in respective fields as indicated at block 123. These plurality of forecasting parameters are utilized to generate forecasting reports in at least one program application as indicated at block 124. The user can monitor the plurality of forecasting reports as indicated at block 125 and can evaluate the daily spending rate generated by the program application as indicated at block 126, the daily or the weekly spending rate helps to monitor one's spending based on savings or investment goals and targets. The method also facilitates the user to evaluate the under/over rate and day variances between an actual spending rate and an allocated spending rate based on savings or investments decisions. The method produces a value variance between an actual spending amount and a subjective value-adjusted amount based on the value factor as indicated at block 127. The rate, day, and value variance is checked as indicated at block 128 and if the calculated value variance yields a positive value that indicates a good spending habit subjectively allows the user to utilize the money for saving or paying off debts as indicated at block 129. If the rate variance is calculated as a negative value, meaning the user needs to change the spending habits so as to reduce spending as indicated at block 130. Ideally, after a few months the user can use the method and system to determine what best fits their own value system and has a clear gauge to evaluate their spending habits.

The method calculates the daily and weekly spending rate 32, monthly spending rate and savings purchases. The preferred embodiment facilitates incorporation of other plurality of program applications 14 for assets, debts, savings, irregular bills and monthly bills. The method may be coded in any programming language.

While a particular form of the invention has been illustrated and described, it will be apparent that various modifications can be made without departing from the spirit and scope of the invention. For example, the method can be utilized to provide trend reports to evaluate the past spending rate and present spending rate and other custom Excel spreadsheets can be interlinked with the program applications 11. Accordingly, it is not intended that the invention be limited, except as by the appended claims.

What is claimed is:

1. A method and system for financial allocation and forecasting, comprising:
receiving a plurality of financial data in a plurality of program applications from at least one user, each program application being formulated to uniquely generate a plurality of forecasting parameters that utilize the plurality of financial data for processing;
receiving a value factor in at least one program application, the value factor being a subjective decision of the user;
generating a plurality of forecasting reports in at least one program application based on the plurality of forecasting parameters, each of the plurality of forecasting reports include a plurality of forecasting metrics;
automatically calculating an under/over value variance based on the rate factor; and
evaluating the under/over value variance between an actual spending amount and an adjusted value amount;
whereby the under/over value variance provides a clear metric to the user to determine the spending is within the user's desired value.

2. The method of claim 1 wherein the plurality of program applications may receive data manually or by way of at least one custom program application.

3. The method of claim 1 wherein the value factor may vary between a range from −3 to +3.

4. The method of claim 1 wherein the under/over value variance is subjectively judged on a zero reference value.

5. The method of claim 1 wherein the under/over value variance is utilized to evaluate daily spending, monthly spending, and savings purchases.

6. A method and system for financial allocation and forecasting, comprising:
receiving a plurality of financial data in a plurality of program applications from at least one user, each program application being formulated to uniquely generate a plurality of forecasting parameters that utilize the plurality of financial data for processing;
generating a plurality of forecasting reports in at least one program application based on the plurality of forecasting parameters, each of the plurality of forecasting reports include a plurality of forecasting metrics; and
automatically calculating a daily and a weekly spending rate in the at least one program application;
whereby the daily and weekly spending rate is calculated dynamically to monitor spending rate based on savings or investments to determine whether the user is saving money, spending savings, or acquiring debt.

7. The method of claim 6 wherein the plurality of program applications may receive data manually or by way of at least one custom program application.

8. The method of claim 6 whereby the number of days over/under daily spending is calculated dynamically to monitor spending rate based on savings or investments to determine whether the user is saving money, spending savings, or acquiring debt.

9. A method and system for financial allocation and forecasting, comprising:
receiving a plurality of financial data in a plurality of program applications from at least one user, each program application being formulated to uniquely generate a plurality of forecasting parameters that utilize the plurality of financial data for processing;
receiving an indication “n” or “N” which is a need for any necessary item and a “w” or “W” which is a want for any optional item or luxury purpose item for the user, in at least one program application; and
generating a plurality of forecasting reports in at least one program application based on the plurality of forecasting parameters, each of the plurality of forecasting reports include a plurality of forecasting metrics;
whereby the method allows the user to categorize an amount of spending on items needs or wants accordingly based on human or business criteria.

10. The method of claim 9 wherein the plurality of program applications may receive data manually or by way of at least one custom program application.

11. The method of claim 1,6, and 9 wherein the plurality of program applications are designed to receive data pertaining to income allocation, cash, equity, assets, debts, daily spending, monthly spending, savings purchases, and value variance.

12. The method of claim 1, 6, and 9 wherein the financial allocation and forecasting method is designed to utilize a Gregorian calendar system for calculations.

13. The method of claim 1, 6, and 9 wherein the financial allocation and forecasting utilizes a fifth week month income occurring in every three months for savings.

14. The method of claim 12 wherein the fifth week month income contributes to 7.7% savings of yearly income.

15. The method of claim 1, 6, and 9 wherein a plurality of transactions may be treated as cash equivalents, the plurality of transactions may include a credit card, check, cash in hand, money order, traveler's checks, or the like.

16. The method of claim 1, 6, and 9 wherein the financial allocation and forecasting may incorporate another plurality of program applications for evaluating assets, debts, savings, irregular bills and monthly bills.

17. The method of claim 1, 6, and 9 wherein the financial allocation and forecasting may be utilized for personal accounting and/or business accounting.

18. The method of claim 1, 6, and 9 wherein the plurality of program applications for the financial allocation and forecasting may be coded in any programming language.

19. The method of claim 1, 6, and 9 wherein the plurality of program applications may function on any operating system such as Windows 3.1, Windows NT, Windows 98, Unix or the like.
